(19) United States
(12) Patent Application Publication
(10) Pub. No.: US 2017/0061135 A1
(43) Pub. Date: Mar. 2, 2017

(54) ELECTRONIC APPARATUS AND METHOD

(71) Applicant: Kabushiki Kaisha Toshiba, Tokyo (JP)

(72) Inventor: Kaoru Ishikawa, Fussa Tokyo (JP)

(21) Appl. No.: 15/053,737

(22) Filed: Feb. 25, 2016

Related U.S. Application Data
(60) Provisional application No. 62/210,916, filed on Aug. 27, 2015.

(51) Int. Cl. G06F 21/57; H04L 29/06

(52) U.S. Cl. CPC G06F 21/577; H04L 63/1433; G06F 2221/034

(57) ABSTRACT

According to one embodiment, an electronic apparatus includes a hardware processor and a memory connected to the hardware processor. The hardware processor is configured to determine whether the electronic apparatus is vulnerable, shut down the electronic apparatus if the electronic apparatus is determined as vulnerable, and the electronic apparatus executes a first operation, and lock the electronic apparatus to prohibit startup of the electronic apparatus in a Basic Input Output System (BIOS) which runs on the electronic apparatus.

### CROSS-REFERENCE TO RELATED APPLICATIONS

This application claims the benefit of U.S. Provisional Application No. 62/210,916, filed Aug. 27, 2015, the entire contents of which are incorporated herein by reference.

### FIELD

Embodiments described herein relate generally to an electronic apparatus and a method.

### BACKGROUND

Recently, companies have introduced a client management system for managing a plurality of devices (hereinafter indicated as clients) such as personal computers used in their companies.

In this client management system, information regarding the IT resources (resources of hardware, software, etc) that the clients have can be collected from the clients, respectively, and it is possible to efficiently manage the IT resources in a company, and reduce the cost of the management.

Also, in the client management system, a security patch (a program for correcting a security deficiency) and virus removal software (software for removing or deleting a virus that the client has become infected with) can be distributed to each of the clients (that is, the security measures can be taken). In this way, the client management system can retain security of each of the clients.

However, if the client is connected to an external network while no security measures as mentioned above are taken, the client may be at risk for receiving unfair attacks from outside. Also, if a client for which the security measures are not taken is connected to a backbone, etc., the other clients may also be harmed.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an illustration showing an example of a network structure of a client management system in the present embodiment.

FIG. 2 is a perspective view showing an example of an appearance of an electronic apparatus according to the present embodiment.

FIG. 3 is a diagram showing an example of a system configuration of the electronic apparatus.

FIG. 4 is a block diagram showing an example of a functional configuration of the electronic apparatus.

FIG. 5 is a flowchart showing an example of a processing procedure of the electronic apparatus.

FIG. 6 is a flowchart showing an example of a processing procedure of unlocking the electronic apparatus.

FIG. 7 is an illustration for describing an outline of the operation of the electronic apparatus.

FIG. 8 is an illustration for describing an outline of the operation of the electronic apparatus.

FIG. 9 is an illustration for describing an outline of the operation of the electronic apparatus.

### DETAILED DESCRIPTION

Various embodiments will be described hereinafter with reference to the accompanying drawings.

In general, according to one embodiment, an electronic apparatus includes a hardware processor and a memory connected to the hardware processor. The hardware processor is configured to determine whether the electronic apparatus is vulnerable, shut down the electronic apparatus if the electronic apparatus is determined as vulnerable, and the electronic apparatus executes a first operation, and lock the electronic apparatus to prohibit startup of the electronic apparatus in a Basic Input Output System (BIOS) which runs on the electronic apparatus.

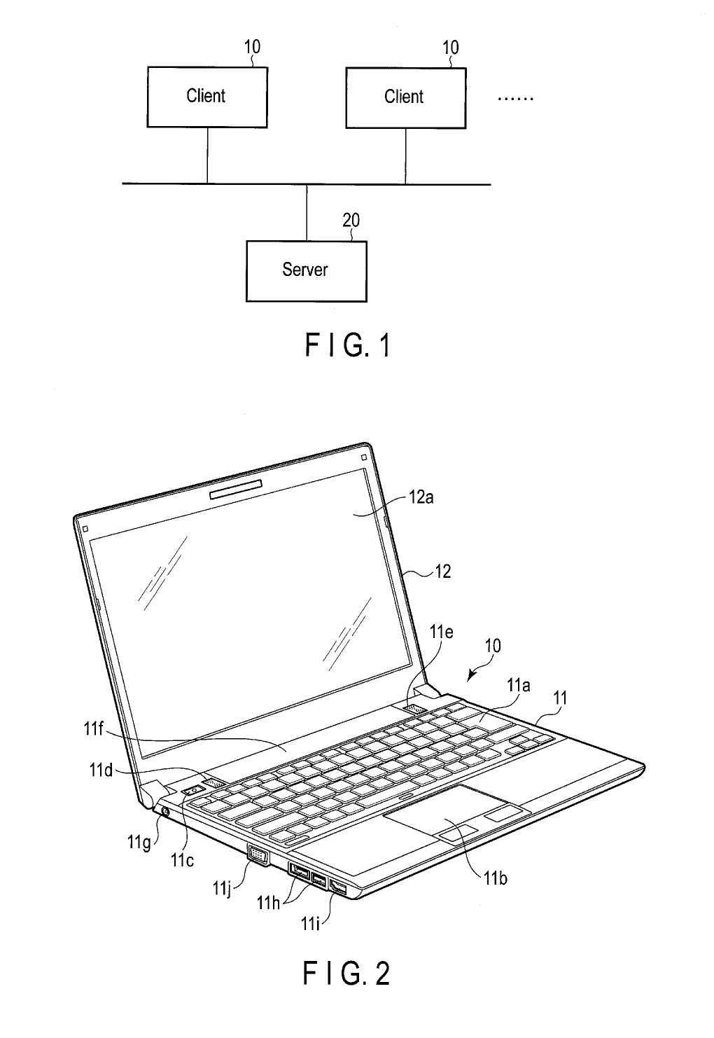

FIG. 1 shows an example of a network structure of a client management system in the present embodiment. As shown in FIG. 1, the client management system includes a client 10 and a server 20.

The client 10 is an electronic apparatus such as a personal computer (PC) used by a user in a company, for example. In the client management system, a plurality of clients 10 exist. The clients 10 are connected to, for example, a backbone laid in the company. Also, the user can take the client 10 out of the company, etc., and use the client 10 by connecting it to an external network.

The server 20 is connected to the plurality of clients 10 so that the server 20 can communicate with the clients 10, and has the function of managing the plurality of clients 10. The server 20 can distribute, for example, a security patch and virus removal software to each of the clients 10, as the measures against vulnerability of each of the clients 10 (hereinafter indicated as security measures). The security patch is a program for correcting the vulnerability of the clients 10. The virus removal software is software (a program) for removing or deleting a virus (a malicious program or file, etc.) that any of the clients 10 has become infected with.

Further, the server 20 can distribute various scripts (programs) executed on the respective clients 10 to the clients 10. Various scripts distributed to the respective clients 10 from the server 20 include a script for security measures (hereinafter indicated as a security measures script). In this security measures script, an operation, etc., of the case where the client 10 is vulnerable is described, for example.

FIG. 2 is a perspective view showing an appearance of the client 10, which is the electronic apparatus of the present embodiment. The client 10 can be realized as a notebook personal computer or a tablet computer, for example. FIG. 2 shows an example in which the client 10 is realized as a notebook PC. In the following, a description will be given assuming that the client 10 according to the present embodiment is realized as a notebook PC, for example.

As shown in FIG. 2, the client 10 includes a main body (a computer main body) 11 and a display unit 12. A display like a liquid crystal display (LCD) 12a is incorporated in the display unit 12.

The display unit 12 is attached to the main body 11 to be rotatable between an open position at which a top surface of the main body 11 is exposed and a closed position at which the top surface of the main body 11 is covered by the display unit 12. The main body 11 includes a housing in the shape of a thin box, and a keyboard 11a, a touchpad 11b, a power switch 11c, speakers 11d and 11e, etc., are arranged on the top surface of the main body 11.

Also, the client 10 is configured to receive electric power from a battery 11f. In the present embodiment, the battery 11f is built into the client 10, for example.

Further, the main body 11 is provided with a power connector (a DC power input socket) 11g. The power connector 11g is provided on a side surface, for example, the left side surface, of the main body 11. An external power supply is detachably connected to the power connector 11g. As the external power supply, an AC adapter may be used. The AC adapter is a power supply which converts a commercial power (AC power) into a DC power.

The client 10 is driven by the power supplied from the battery 11f or the power supplied from the external power supply. The client 10 is driven by the power supplied from the battery 11f if the external power supply is not connected to the power connector 11g of the client 10. Meanwhile, if the external power supply is connected to the power connector 11g of the client 10, the client 10 is driven by the power supplied from the external power supply. Also, the power supplied from the external power supply is used to charge the battery 11f.

Further, several USB ports 11h, a high-definition multimedia interface (HDMI) (registered trademark) output socket 11i, and an RGB port 11j are provided on main body 11.

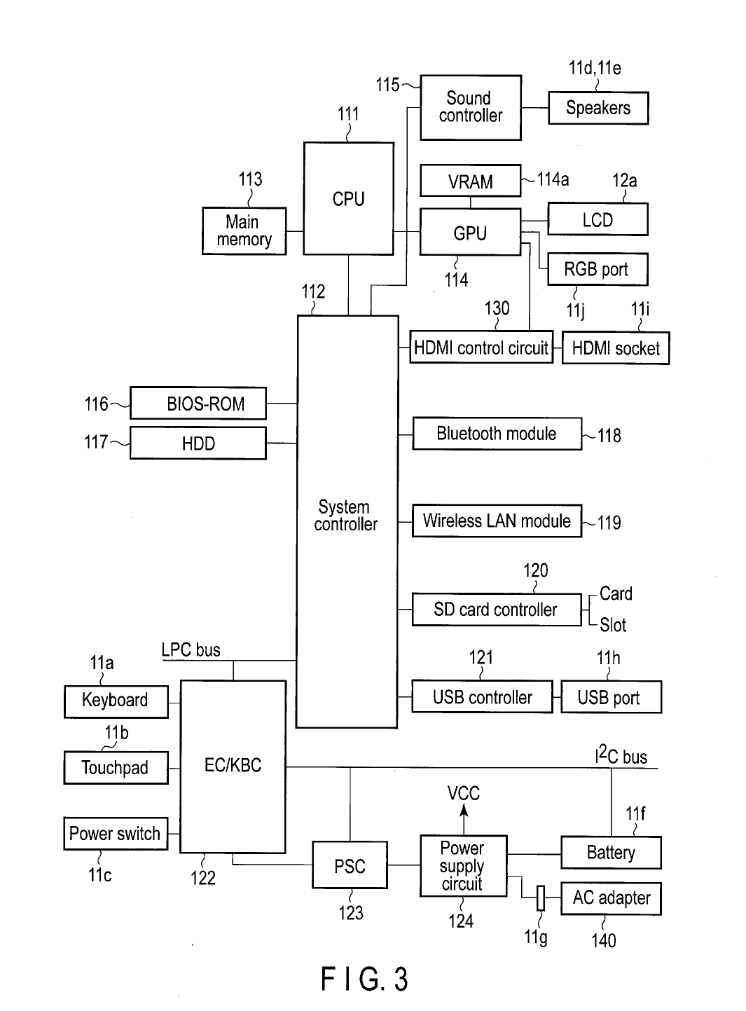

FIG. 3 shows a system configuration of the client 10 shown in FIG. 2. The client 10 includes a CPU 111, a system controller 112, a main memory 113, a graphics processing unit (GPU) 114, a sound controller 115, a BIOS-ROM 116, a hard disk drive (HDD) 117, a Bluetooth (registered trademark) module 118, a wireless LAN module 119, an SD card controller 120, a USB controller 121, an embedded controller/keyboard controller IC (EC/KBC) 122, a power supply controller (PSC) 123, a power supply circuit 124, etc.

The CPU 111 is a hardware processor configured to control the operation of each of the components of the client 10. The hardware processor includes a processing circuit. The CPU 111 executes software such as an operating system (OS) which is loaded from the HDD 117 into the main memory 113. Further, the CPU 111 executes the security measures script, for example, which is distributed to the client 10 from the server 20.

Furthermore, the CPU 111 executes a Basic Input/Output System (BIOS) stored in the BIOS-ROM 116 which is a nonvolatile memory. The BIOS is a system program for hardware control.

The system controller 112 is a bridge device configured to connect between CPU 111 and each of the components. In the system controller 112, a serial ATA controller for controlling the HDD 117 is integrated. Further, the system controller 112 executes communication with each of the devices on a Low PIN Count (LPC) bus.

The GPU 114 is a display controller configured to control the LCD 12a employed as a display (monitor) of the client 10. The GPU 114 generates a display signal (LVDS signal) which should be supplied to the LCD 12a from display data stored in a video memory (VRAM) 114a.

Further, the GPU 114 can also generate an HDMI video signal and an analog RGB signal from the display data. The HDMI output socket 11i can transmit the HDMI video signal (uncompressed digital video signal) and a digital audio signal to an external display connected by a cable. In addition, the analog RGB signal is supplied to the external display via the RGB port 11j.

Note that an HDMI control circuit 130 shown in FIG. 3 is an interface configured to transmit the HDMI video signal and the digital audio signal to the external display via the HDMI output socket 11i.

The sound controller 115 is a sound source device, and outputs audio data to be reproduced to the speakers 11d and 11d, for example.

The Bluetooth module 118 is a module configured to execute wireless communication with a Bluetooth-enabled device by using the Bluetooth.

The wireless LAN module 119 is a module configured to execute wireless communication conforming to the IEEE 802.11 standard, for example.

The SD card controller 120 executes a write and a read of data with respect to a memory card inserted into a card slot provided in the main body 11.

The USB controller 121 executes communication with an external device connected via the USB port 11h.

The EC/KBC 122 is connected to the LPC bus. Also, the EC/KBC 122, the PSC 123, and the battery 11f are interconnected through a serial bus such as an I²C bus.

The EC/KBC 122 is a power management controller configured to execute power management of the client 10, and is implemented as, for example, a single-chip microcomputer containing a keyboard controller which controls the keyboard (KB) 11a, the touchpad 11b, etc. The EC/KBC 122 has the function of powering the client 10 on and off in accordance with the user's operation on the power switch 11c. The control of powering the client 10 on and off is executed by a cooperative operation of the EC/KBC 122 and the PSC 123. If the PSC 123 receives an ON signal transmitted from the EC/KBC 122, the PSC 123 controls the power supply circuit 124 to power on the client 10. Also, if the PSC 123 receives an OFF signal transmitted from the EC/KBC 122, the PSC 123 controls the power supply circuit 124 to power off the client 10.

Note that if the client 10 is powered on, the BIOS and the OS are sequentially executed (started) on the client 10. As a result, the user is able to use the client 10.

The power supply circuit 124 generates power (operating power Vcc) to be supplied to each of the components by using the power supplied from the battery 11f or the power supplied from an AC adapter 140 connected to the main body 11 as the external power supply.

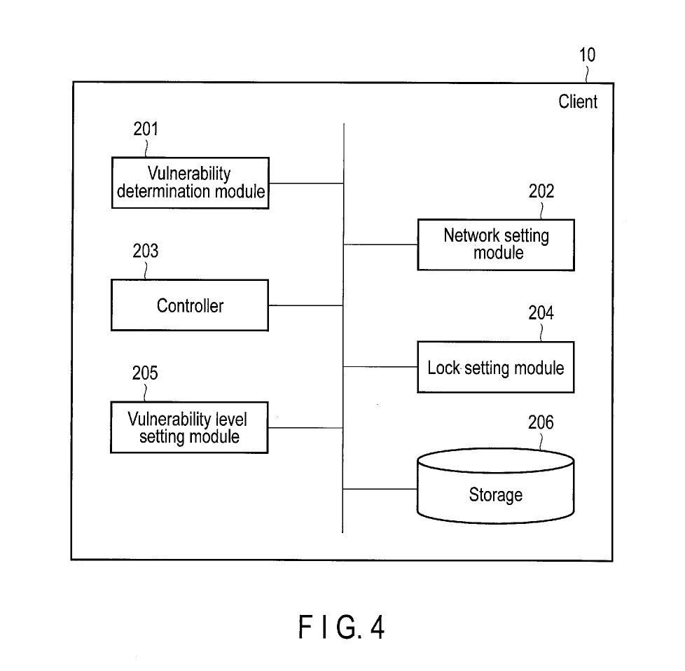

FIG. 4 is a block diagram showing a functional configuration of the client 10 (the electronic apparatus) according to the present embodiment. As shown in FIG. 4, the client 10 includes a vulnerability determination module 201, a network setting module 202, a controller 203, a lock setting module 204, a vulnerability level setting module 205, and a storage 206.

In the present embodiment, a part or all of the vulnerability determination module 201, the network setting module 202, the controller 203, the lock setting module 204, and the vulnerability level setting module 205 are to be realized as the CPU 111 executes the above-described security measures script (software). Note that a part or all of the modules 201 to 205 may be realized by hardware such as an integrated circuit (IC), or a structure of a combination of software and hardware. Also, in the present embodiment, it is assumed that the storage 206 is stored in the HDD 117, etc., described above.

The vulnerability determination module 201 determines whether the client 10 is vulnerable (i.e., whether there is security deficiency in the client 10). Whether the client 10 is vulnerable is determined based on whether the security measures are taken with respect to the client 10, for example.

The network setting module 202 performs the setting of a network that the client 10 is connected to. More specifically, if the client 10 is vulnerable, the network setting module 202 switches the network settings of the client 10, for example, thereby connecting the client 10 in question to a private network (hereinafter indicated as a dedicated network) through which the client 10 can communicate with only the above-mentioned server 20.

The controller 203 executes a process of shutting down the client 10 in question in accordance with a predetermined operation of the client 10 which is vulnerable.

The lock setting module 204 sets a lock state with respect to the client 10 if the client 10 is shut down by the controller 203. More specifically, the lock setting module 204 locks the client 10 to prohibit the startup of the client 10 in a BIOS which is operated (executed) on the client 10.

The vulnerability level setting module 205 sets the level of vulnerability (hereinafter indicated as the vulnerability level) at which the controller 203 shuts down the client 10 and the lock setting module 204 locks the client 10 as described above in accordance with an operation of a manager of the client management system, for example. As the vulnerability level of the above case, conditions that the security patch is not distributed, and the client is infected with a virus, for example, are included.

Here, a case where a condition that a security patch is not distributed is set as the vulnerability level is assumed. According to such setting, if no security patch is distributed to the client 10, in a determination process by the vulnerability determination module 201, it is determined that the client 10 is vulnerable. Meanwhile, a case where a condition that the client is infected with a virus is set as the vulnerability level is assumed. According to such setting, if the client 10 is infected with a virus, in a determination process by the vulnerability determination module 201, it is determined that the client 10 is vulnerable.

As the vulnerability level, conditions that a security patch is not distributed and the client is infected with a virus may be set. According to such setting, if no security patch is distributed to the client 10, or if the client 10 is infected with a virus, it is determined that the client 10 has vulnerability.

It should be noted that as the vulnerability level, conditions that a specific security patch is not distributed, or the client is infected with a specific virus, etc., may be set.

Since the vulnerability level described above is only an example, the other vulnerability level, such as the condition that software other than the one prescribed in advance (i.e., software of low safety and reliability level) is installed, may be set.

The vulnerability level set by the vulnerability level setting module 205 is stored in, for example, the storage 206.

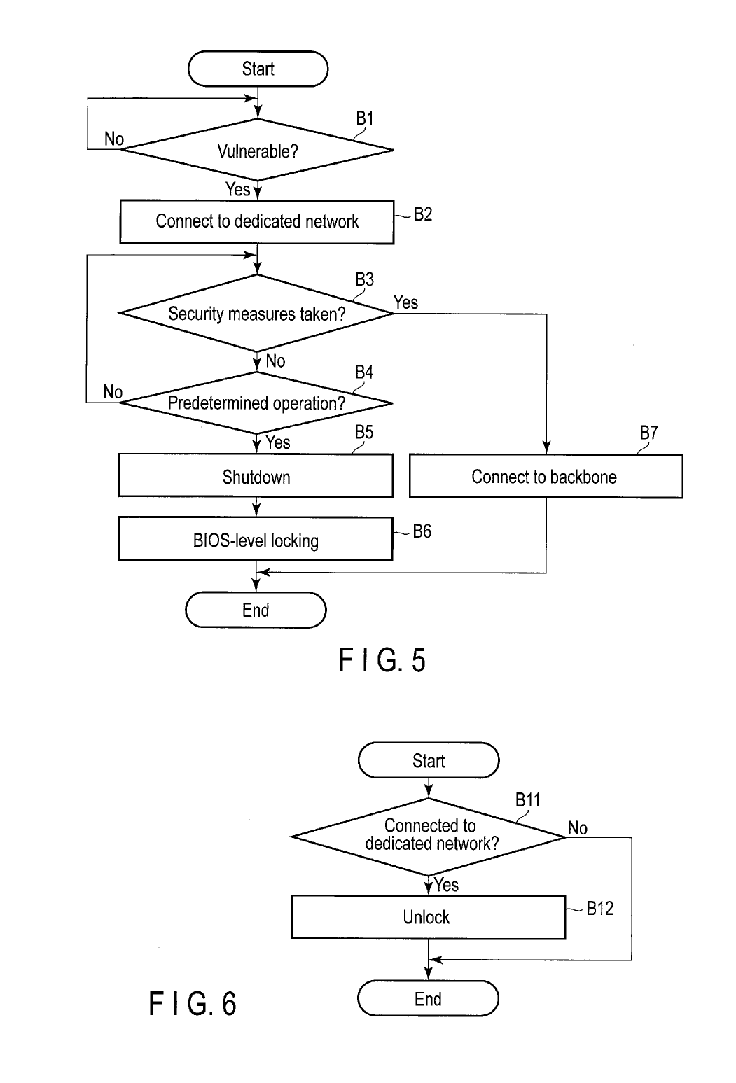

Next, referring to the flowchart of FIG. 5, a processing procedure of the client 10 according to the present embodiment will be described. In the following description, it is assumed that the conditions that a security patch is not distributed and the client is infected with a virus are set as the vulnerability level, and this vulnerability level is stored in the storage 206. Also, it is assumed that the client 10 is in the state in which it is connected to the above-mentioned backbone.

The processes of the client 10 described below are realized by the security measures script.

First, the vulnerability determination module 201 determines whether the client 10 is vulnerable based on the vulnerability level stored in the storage 206 (block B1). Here, as described above, if a security patch is not distributed (the latest security patch is not correctly applied) to the client 10, or if the client 10 is infected with a virus, the vulnerability determination module 201 determines that the client 10 is vulnerable.

Whether the security patch is distributed to the client 10 can be determined by establishing communication between the client 10 and the server 20 which distributes the security patch, and comparing the security patch applied to the client 10 and the security patch managed in the server 20, for example. Also, whether the client 10 is infected with the virus can be determined by executing a virus detection program, etc., on this client 10.

If it is determined that the client 10 is not vulnerable (NO in block B1), the process of block B1 is repeated.

Meanwhile, if it is determined that the client 10 is vulnerable (YES in block B1), the network setting module 202 connects the client 10 to the above-mentioned dedicated network (block B2). In other words, the network setting module 202 disconnects the client 10 from the backbone, and connects the client 10 to a private network through which the client 10 can communicate with only the server 20.

Here, if the client 10 can communicate with the server 20, the server 20 can take measures such as distributing the security patch and virus removal software to the client 10, for example.

Hence, the client 10 determines whether the security measures are taken by the server 20 (that is, whether the vulnerability of the client 10 is remedied) (block B3).

If it is determined that the security measures are not taken (NO in block B3), the controller 203 determines whether the client 10 has performed a predetermined operation (block B4). The predetermined operation in block B4 includes the operation of attempting to connect to a network other than the dedicated network, for example.

More specifically, if a client 10 which is infected with a virus is connected to, for example, the backbone, the other clients 10 which are connected to the backbone may also be harmed. In the present embodiment, in order to avoid such a situation, it is assumed that the operation of attempting to connect to the backbone is set as the predetermined operation in block B4.

Further, if a client 10 to which the security patch is not correctly applied is connected to a network (external network) which is beyond management of the client management system, there is a risk that this client 10 will be attacked from outside. In the present embodiment, in order to avoid such a situation, it is assumed that the operation of attempting to connect to the external network is set as the predetermined operation in block B4.

Here, although the operation of attempting to connect to a network (the backbone and the external network) other than the dedicated network has been described as an example of the predetermined operation, as the predetermined operation, an operation of changing the settings of the network, for example, may be set. Also, the predetermined operation in block B4 may be structured in such a way that it can be changed as appropriate according to the situation or the like in which the client 10 is used.

If it is determined that the client 10 does not perform the predetermined operation (NO in block B4), the flow returns to block B3 and the process is repeated.

Meanwhile, if it is determined that the client 10 performs the predetermined operation (YES in block B4), the controller 203 shuts down the client 10 (block B5).

Further, if the client 10 is shut down, the lock setting module 204 performs the setting of locking the client 10 at a BIOS level (block B6). Accordingly, even if the client 10 is powered on after shutdown, the startup of the client 10 is prohibited in the BIOS (that is, the startup is disabled).

Meanwhile, if it is determined that the security measures are taken in block B3 (YES in block B3), the network setting module 202 switches the network settings of the client 10, thereby allowing the client 10 to be connected to a network other than the dedicated network. More specifically, the network setting module 202 connects the client 10 to the backbone, for example (block B7). After the process of block B7 has been executed, the processes of FIG. 5 are to be executed regularly.

According to above the processes shown in FIG. 5, if a client 10 determined as being vulnerable (that is, the client for which the security measures are yet to be taken) performs a predetermined operation before the security measures are taken for this client 10, the client 10 is shut down, and locked at the BIOS level.

It has been described that in the processes shown in FIG. 5, if the client 10 determined as being vulnerable performs the predetermined operation, the client 10 is shut down, and locked at the BIOS level. However, the validity/invalidity of the shutdown (that is, whether the client 10 should be shut down), or the validity/invalidity of the locking (that is, whether the client 10 should be locked) can be set (changed) by the manager, etc.

Here, in order for the user to use the client 10 locked at the BIOS level as described above (the client 10 in a locked state), the client 10 must be unlocked. Hereinafter, by referring to the flowchart of FIG. 6, a processing procedure of unlocking the client 10 will be described.

As described above, since the locked client 10 is vulnerable, it is necessary to take the security measures by the server 20. Accordingly, in the present embodiment, it is assumed that the connection of the client 10 to the dedicated network (or the client 10 being in a connectable state) is set as the condition of unlocking.

In this case, if the locked client 10 is powered on, the BIOS is started (executed) on the client 10, and it is determined whether the client 10 is connected to the dedicated network (block B11).

If it is determined that the client 10 is connected to the dedicated network (YES in block B11), the lock (state) at the BIOS level set by the lock setting module 204 is unlocked (block B12). Once unlocked, the OS is started on the client 10, and the user can use the client 10.

Note that the client 10 in this case is vulnerable and is connected to the dedicated network. Accordingly, after the process of block B12 has been executed, the processes starting from block B3 shown in FIG. 5 are executed, although this is omitted in the illustration of FIG. 6. That is, if the client 10 attempts to connect to a network other than the dedicated network in a state in which no security measures are taken for the client 10, the client 10 in question is shut down as described above, and locked at the BIOS level. Meanwhile, if the security measures are taken for the client 10 by communication with the server 20 via the dedicated network, the client 10 is connected to the backbone.

In contrast, if it is determined that the client 10 is not connected to the dedicated network (NO in block B11), the process of block B12 is not executed and the user cannot use (start) the client 10.

According to the processes shown in FIG. 6, even if the client 10 is locked, if the client 10 is in the state in which the client 10 is connected to the dedicated network, the client 10 in question can be started, and the security measures can be taken for this client 10.

Further, in the processes shown in FIG. 6, it has been described that the condition of unlocking the client 10 is that the client 10 is connected to the dedicated network. However, the condition of unlocking may be settable (changeable) by the manager, etc.

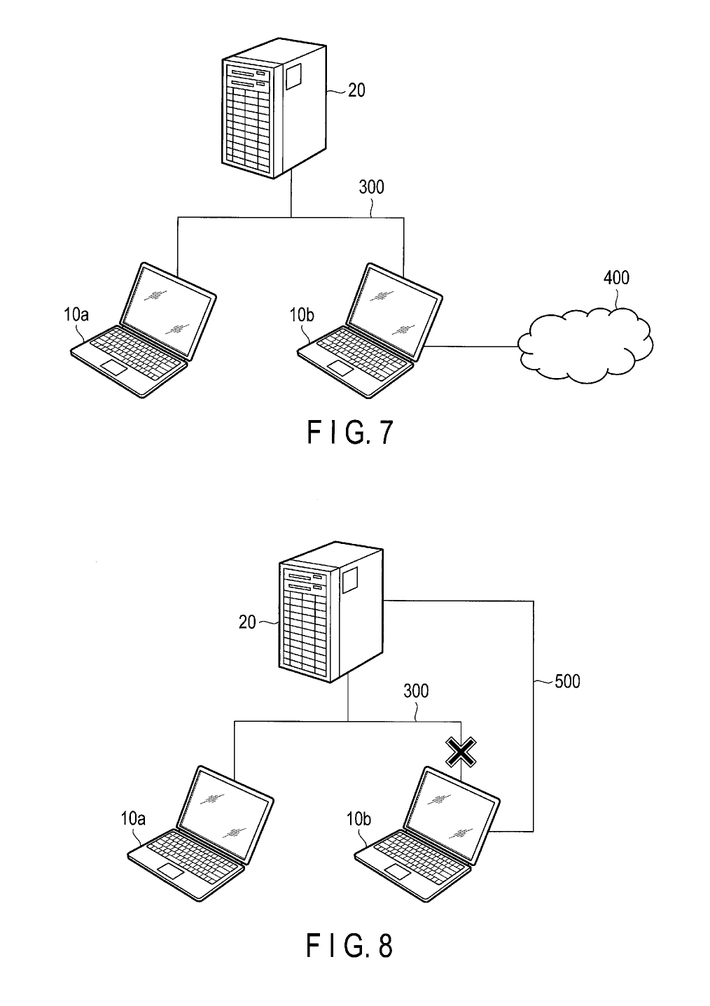

Next, referring to FIGS. 7 to 9, an outline of the operation of the client according to the present embodiment will be described.

Here, as shown in FIG. 7, a client management system including two clients, i.e., clients 10a and 10b, used by a user in a company, and the server 20 for taking security measures with respect to a plurality of clients 10 including the aforementioned clients 10a and 10b is assumed. In such a client management system, (the plurality of clients 10 including) clients 10a and 10b are connected to a backbone 300 laid in the company, and can communicate with the server 20 via the backbone 300. Also, if the user takes client 10b, for example, outside the company, client 10b can be used in a state in which it is connected to an outside (external) network 400.

Here, a case where client 10b is infected with a virus (that is, the client 10b is vulnerable) is assumed. In this case, if client 10b is in a state in which it is connected to the backbone 300, there is a possibility that client 10a will also be harmed through the backbone 300. For this reason, as shown in FIG. 8, client 10b is disconnected from the backbone 300, and connected to a dedicated network 500 through which client 10b can communicate with only the server 20. In this case, if client 10b is in a state in which it is connected to the dedicated network 500, the user can use this client 10b.

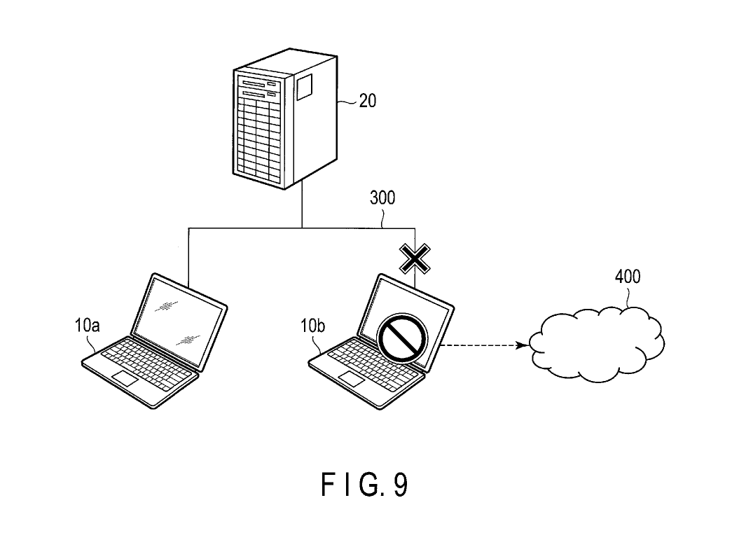

In contrast, as shown in FIG. 9, in the case where the user takes client 10b which is vulnerable out of the company, for example, and tries to connect it to the outside network 400 (or if the network settings have been changed), client 10b is shut down forcibly and locked at the BIOS level. If client 10b is locked, the user can take the locked client 10b back to the company for the time being and have this client 10b connected to the dedicated network 500, thereby allowing client 10b to be started and used.

It should be noted that the same applies to the case of connecting client 10b which is vulnerable to the backbone 300, although this is not illustrated in the drawings.

As described above, in the present embodiment, if the client 10 (the electronic apparatus) is vulnerable, and the client 10 executes the predetermined operation, the client 10 is shut down and locked at the BIOS level. That is, in the present embodiment, startup control by the security measures script is executed on the client 10 which is vulnerable. Note that in the present embodiment, for example, if a predetermined security patch is not applied to the client 10, or if the client 10 is infected with a virus, it is determined that the client 10 is vulnerable. Also, in the present embodiment, the predetermined operation includes the operation of attempting to connect the client 10 to a network other than the dedicated network (i.e., a private network through which the client 10 can communicate with only the server 20 for taking the security measures with respect to the client 10).

In the present embodiment, by such a structure, it is possible to prevent a user who does not know that the client 10 is vulnerable or a malicious third person from connecting the client 10 (for example, the client 10 to which the latest security patch is not applied) to the external network, thereby subjecting the client 10 under unfair attack from outside. Further, in the present embodiment, it becomes possible to avoid a situation in which clients 10 other than the client 10 infected with a virus, for example, are also harmed as a result of the client 10 in question being connected to the backbone. That is, in the present embodiment, it becomes possible to keep down ill effect caused by the client 10 which is vulnerable to the minimum, and accomplish security enhancement in the client management system.

Also, because of a structure which enables the client 10 to be locked at the BIOS level, since the OS is not started even if the client 10 is powered on while the client 10 is not being connected to the dedicated network, programs which can be executed on the client 10 are limited. That is, in the present embodiment, in a case where the client 10 is infected with a virus which operates on the OS, the damage can be reduced to the minimum extent.

Also, in the present embodiment, the client 10 which is locked as described above can be started if it is connected to the dedicated network. According to such a structure, since the client 10 can be started in a state in which the security measures can be taken by the server 20, it becomes possible to implement the security measures with respect to the client 10 promptly.

In the present embodiment, by adopting the structure of connecting the client 10 to the dedicated network if it is determined that this client 10 is vulnerable, the security measures can be taken with respect to the client 10 by establishing communication between the client 10 and the server 20 while maintaining (securing) security within the aforementioned client management system. Note that if the security measures are taken with respect to the client 10, the client 10 can be connected to a network other than the dedicated network. In this case, the user can use the client 10 by connecting it to the backbone or the external network, etc.

Further, in the present embodiment, it has been described that the dedicated network to which the client 10, which is determined as being vulnerable, is connected is a private network through which the client 10 can mainly communicate with only the server 20. However, as long as the security within the client management system can be maintained (secured), the dedicated network can be any kind of network which enables communication to be carried out with at least the server 20 for taking the security measures.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a hardware processor and
a memory connected to the hardware processor,
wherein the hardware processor is configured to:
determine whether the electronic apparatus is vulnerable;
shut down the electronic apparatus if the electronic apparatus is determined as vulnerable, and the electronic apparatus executes a first operation; and
lock the electronic apparatus to prohibit startup of the electronic apparatus in a Basic Input Output System (BIOS) which runs on the electronic apparatus.

2. The electronic apparatus of claim 1, wherein the hardware processor is configured to allow the locked electronic apparatus to be started if this electronic apparatus is connected to a dedicated network through which the locked electronic apparatus is communicable with a server for taking security measures for at least this electronic apparatus.

3. The electronic apparatus of claim 2, wherein the hardware processor is configured to connect the electronic apparatus to the dedicated network if the electronic apparatus is determined as vulnerable.

4. The electronic apparatus of claim 3, wherein the hardware processor is configured to allow the electronic apparatus to be connected to a network other than the dedicated network if the security measures for the electronic apparatus are taken as communication with the server is conducted.

5. The electronic apparatus of claim 4, wherein the first operation includes an operation of connecting the electronic apparatus to a network other than the dedicated network.

6. The electronic apparatus of claim 1, wherein the hardware processor is configured determine that the electronic apparatus is vulnerable if a security patch is not applied to the electronic apparatus, or if the electronic apparatus is infected with a virus.

7. The electronic apparatus of claim 1, wherein the hardware processor comprises:
means for determining whether the electronic apparatus is vulnerable;
means for shutting down the electronic apparatus if the electronic apparatus is determined as vulnerable, and the electronic apparatus executes a first operation; and
means for locking the electronic apparatus to prohibit startup of the electronic apparatus in a Basic Input Output System (BIOS) which runs on the electronic apparatus.

8. A method comprising:
determining whether an electronic apparatus is vulnerable;
shutting down the electronic apparatus if the electronic apparatus is determined as vulnerable, and the electronic apparatus executes a first operation; and
locking the electronic apparatus to prohibit startup of the electronic apparatus in a Basic Input Output System (BIOS) which runs on the electronic apparatus.
